(19) United States
(12) Patent Application Publication
(10) Pub. No.: US 2013/0086782 A1
(43) Pub. Date: Apr. 11, 2013

(54) Release Tool

(71) Applicant: Douglas Allen Dewell, Mission Viejo, CA (US)

(72) Inventor: Douglas Allen Dewell, Mission Viejo, CA (US)

(21) Appl. No.: 13/271,086

(22) Filed: Oct. 11, 2011

(51) Int. Cl. B23P 19/04

(52) U.S. Cl. 29/237

(57) ABSTRACT

A tool for removing a ferrule and tube from a pneumatic hose fitting comprising first and second jaws each having two upstanding members separated by a U shaped opening for receiving a pneumatic tube fitting of a specific diameter, wherein the upstanding members each have a blunt wedge shaped gripper running around the inside of the U shaped opening extending inward along the side facing the opposite jaw, wherein the first and second jaws are adapted to be coupled to a MAC Tools HCP500 Large Hose Clamp Vise or equivalent for movement toward and away from each other for removing a ferrule and tube from a pneumatic hose fitting made by the PARKER Corp. when positioned to engage the gap between the ferrule and body of the fitting.

### BACKGROUND OF THE INVENTION

1. Field of the Invention

The present invention is directed to a release tool for use with connect tube connectors and, more particularly to a release tool for releasing a plastic air line tubular conduit from a pneumatic fitting typically used in ground transportation equipment such as trucks and buses.

2. Description of Related Art

Snap-fit or quick connect fittings such as pneumatic air fittings are useful in a wide range of applications. In particular, they are frequently employed for joining fluid carrying conduits such as pneumatic air fittings in busses and trucks. Release tools for separating the fluid carrying conduit from its fitting is known in the prior art. More specifically, by way of example, U.S. Pat. No. 7,062,833 to Schann, et al. discloses a sheath that enters between each tab and the cylindrical wall until the means that prevents the withdrawal of locking tabs are released.

U.S. Pat. No. 5,533,761 to Ostrander, et al. discloses axial sliding a release member through an open end of a quick connector into engagement with a retainer mounted within the quick connector to effect release of legs of the retainer from an annular flange on the fitting and disengagement of the connector from the fitting.

U.S. Pat. No. 5,378,025 to Szabo discloses engaging surfaces formed between fingers on an inner sleeve engage deflectable legs on a retainer mounted in the bore of a female connector part where a release member is forcibly urged into the bore in the female connector part to deflect the legs radially outward so as to permit separation of a radially expanded flange on a male conduit from the female connector part.

U.S. Pat. No. 5,228,788 to McNaughton, et al. discloses a plurality of planar surfaces at an outer peripheral surface which bias retainer legs radially outwardly to allow removal of a tube.

U.S. Pat. No. 5,226,230 to Klinger discloses an elongated handle and a bifurcated body including first and second complimentary body halves which are resiliently carried by the handle which embrace an outer surface of the connector to overlie radial openings. An abutment member which extends from the body halves penetrates the female connector opening(s) to displace the retaining element from an engaged position to a released position.

U.S. Pat. No. 5,213,376 to Szabo discloses a squeeze-to-release quick connector for engaging a flanged male member includes a cylindrical body portion which is open at one end for receiving the male member and forms a conduit receiving adapter at its opposite end.

U.S. Pat. No. 5,084,954 to Klinger discloses a quick connector release tool includes a handle and a bifurcated body resiliently mounted to the handle and including one or more finger members extending from each half of the body which form a tapered fitting receiving passageway which is adapted to disconnect male tubular fittings of varying diameters.

U.S. Pat. No. 5,024,468 to Burge discloses a release tool for releasing a tube which is held by the gripper ring of the fitting. The release tool has a thin, cylindrical section portion which can be received about a tube held in the fitting and then inserted in the fitting raises the gripper to release the tube.

### SUMMARY OF THE INVENTION

In an exemplary embodiment of the present invention, there is disclosed a tool for removing a ferrule and tube from a pneumatic tube fitting comprising a first jaw having two upstanding members separated by a U shaped opening for receiving a pneumatic tube fitting of a specific diameter, wherein the two upstanding members support a blunt edged wedge shaped blade to provide a gripping function along the edge of the U shaped opening, and a second jaw having two upstanding members separated by a U shaped opening for receiving the pneumatic tube fitting, wherein the two upstanding members support a blunt edged wedge shaped blade to provide a gripping function along the edge of the U shaped opening, wherein the first and second jaws are adapted to be coupled to a MAC Tools HCP500 Large Hose Clamp Vise or equivalent for movement toward and away from each other for removing a ferrule and tube from a pneumatic tube fitting made by the PARKER Corp. when positioned to engage the gap between the ferrule and body of the fitting.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of a typical prior art nylon air tube with ferrule and nut;

FIG. 2 is a side view of a tube and ferrule engaged in a fitting ferrule's conic section, swaged onto a tube and into the fitting's conic inlet and over the inner support tube;

FIG. 3 is a side view of a typical “Parker” type pneumatic air fitting;

FIGS. 4 and 5 illustrate the new improved jaw members here disclosed coupled to a vise like member, shown in dashed outline, such as the “Large Hose Clamp Vise HCP500” tool manufactured by the “Mac Tools Corporation” being used to remove an air line tube from a pneumatic fitting which is typically used in ground transport equipment such as trucks and buses;

FIGS. 6A-6D show an embodiment of a pair of jaw members adapted to be attached to the tool jaws of the Mac Hose Clamp Vise HCP500 for use in removing 3/8, 1/2, 5/8, and ¾ inch diameter tubing from ferrules where FIG. 6D is a enlarged view of the top end of FIG. 6B showing the wedge shaped blunt edge gripper in accordance with the principles of the invention;

FIGS. 7A, 7B, and 7C show an embodiment of a pair of jaw members, FIGS. 7A, 7B, adapted to be attached directly to the frame of a Mac Hose Clamp Vise HCP500 for use in removing 3/8, 1/2, 5/8, and ¾ inch diameter tubing from ferrules in accordance with the principles of the invention and FIG. 7C shows the jaws attached to a MAC tool HCP500 shown in phantom;

FIGS. 8A-8C show an embodiment of a pair of jaw members adapted to be attached to the tool jaws of the Mac Hose Clamp Vise HCP500 for use in removing 3/8, 1/2, 5/8, and ¾ inch diameter tubing from ferrules in accordance with the principles of the invention; and

FIGS. 9A, 9B show an embodiment of a pair of adjustable jaw members mounted on the frame of the tool jaws of the Mac Hose Clamp Vise HCP500 for use in removing 3/8, 1/2, 5/8, or ¾ inch diameter tubing from ferrules in accordance with the principles of the invention.

### DESCRIPTION OF THE PREFERRED EMBODIMENT

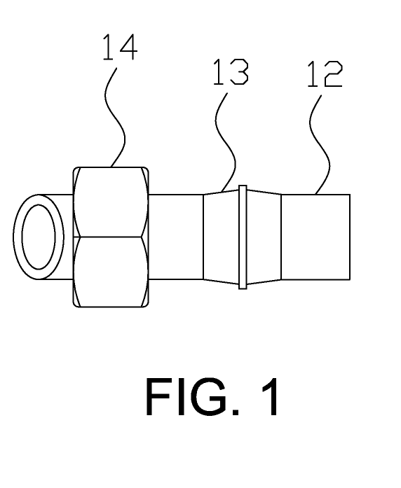

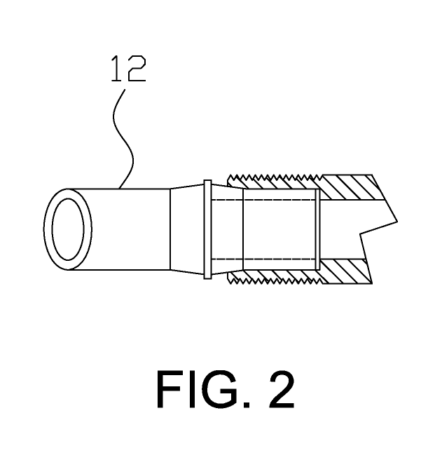

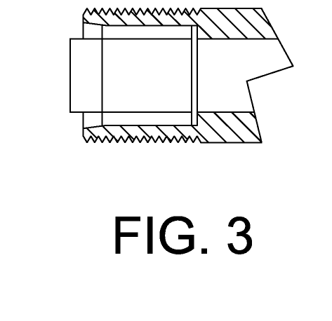

FIGS. 1, 2, and 3 show three views of a typical “Parker” type of pneumatic air fitting with nylon air tube attached to a typical ferrule and nut. Referring to FIG. 1, there is shown a side view of a typical nylon air tube 12 attached to a ferrule 13 and nut 14. FIG. 2 is a partial sectional view of FIG. 1 showing the tube 12 and ferrule engaged in the fitting conic section and swaged onto the tube and into the fittings conical shaped inlet where the tube is positioned over the inner support tube of the ferrule. FIG. 2 is a side view of a typical “Parker” type pneumatic air fitting showing the inside details of the ferrule and tube being squeezed together, thus making removal difficult without rocking the tube back and forth to dislodge the tube and ferrule, as the ferrule makes an interference fit inside the fitting.

The tool disclosed consists of a pair of new improved shaped jaws designed to be attached to the “MAC TOOLS HCP500—LARGE HOSE CLAMP VISE” to allow a nylon air hose to be easily removed from a ferrule fitting typically used in ground transport equipment such as trucks and buses.

Briefly, the Large Hose Clamp Vise Mac tool HCP500 which is manufactured by the MAC TOOLS CORP. consists of two guide rails and a screw for moving a movable jaw toward and away from a fixed jaw.

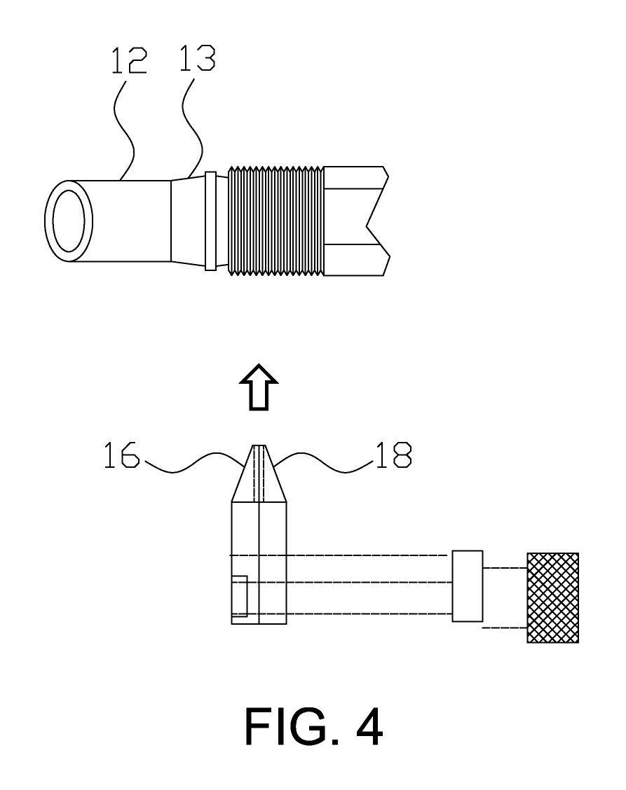

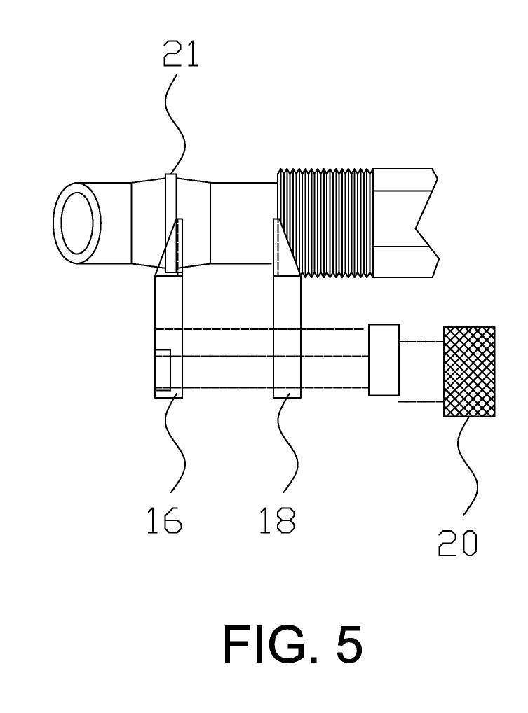

Referring to FIGS. 4 and 5, there is shown the jaw members and vise like member, shown in phantom, such as the “Large Hose Clamp Vise HCP500” tool manufactured by the “Mac Tools Corporation” which is being used to remove an air line tube from a pneumatic fitting which is typically used in ground transport equipment such as trucks and buses. In FIG. 4 the fixed jaw 16 and the movable jaw 18 are positioned next to each other and are placed between the end of the fitting and the ridge 21 of the ferrule. As the knob 20 of the MAC hose vise clamp is turned in a counter clockwise direction, the jaws move away from each other to separate the tube 12 from the fitting.

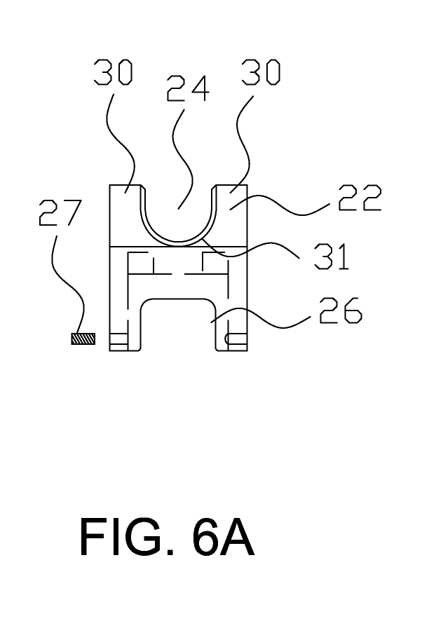

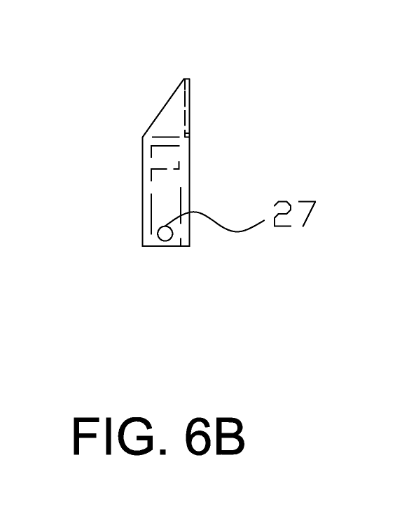

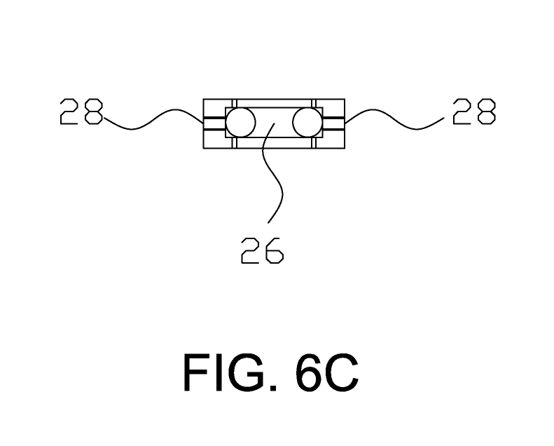

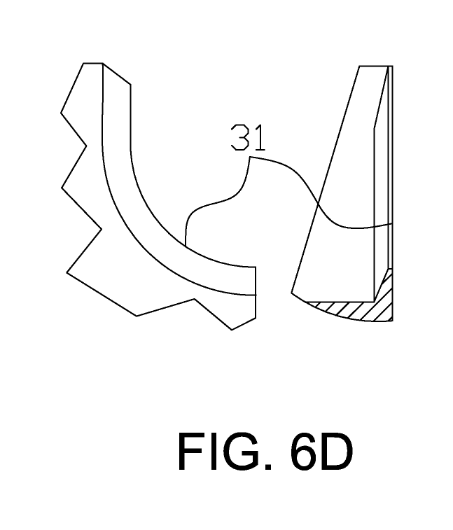

Referring to FIGS. 6A-6C, there is shown an embodiment of one jaw of a pair of jaw members adapted to be attached directly to the tool jaws of the Mac Hose Clamp Vise HCP500 for use in removing a 3/8, 1/2, 5/8, or ¾ inch diameter tube from a ferrule fitting in accordance with the principles of the invention. In this embodiment the fixed jaw is similar to the movable jaw and, therefore, only one jaw 22 is shown. In the FIGS., FIG. 6A is a front view of the jaw 22, FIG. 6B is a side view of the jaw 22, and FIG. 6C is a bottom view of the jaw 22. The jaw 22 has two upstanding members 30 separated by a U shaped opening 24 which is sized to fit ferrules of 3/8, 1/2, 5/8, and ¾ inch tubing. Each upstanding member 30 forms a U Shaped opening that has as its gripping feature, a U shaped blunt wedge 31 running along the edge of the U that faces the opposing jaw. This blunt wedge 31 extends inward and has a radius to prevent marring of the ferrule and protect a user's hands where the edges of the grippers of the two jaws when positioned next to each other can be located between the end of the fitting and the ridge 21 of the ferrule. The lower portion of the jaw has a rectangular opening 26 which is sized to fit around the jaw of the MAC tool. The lower portion of the jaw includes two threaded openings 28 for receiving ball plungers 27 which are used to secure the jaw 22 to the tool jaw of the MAC tool.

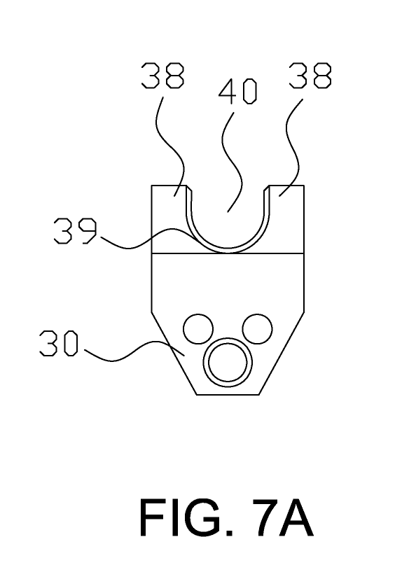

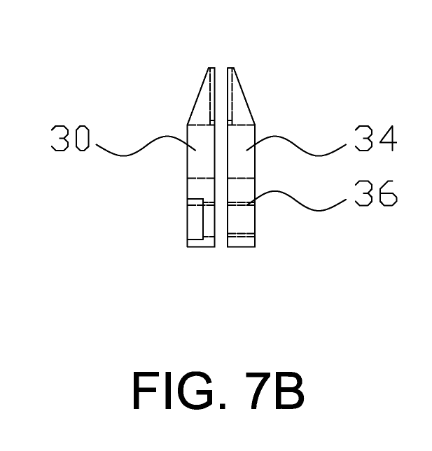

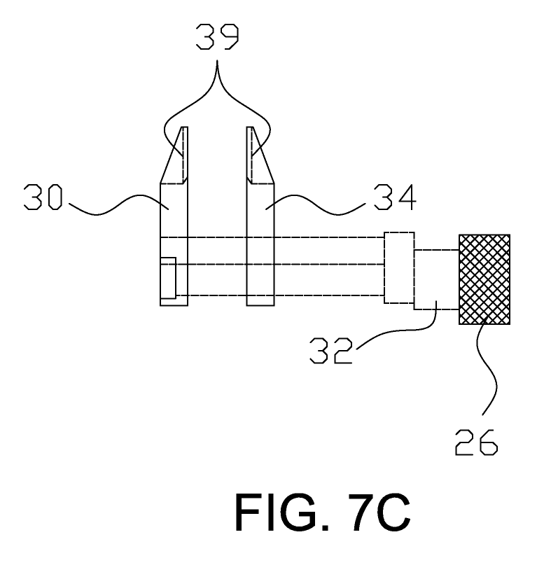

Referring to FIGS. 7A-7C, there is shown an embodiment of a pair of jaw members adapted to be attached directly to the screw and rails of a Mac Hose Clamp Vise HCP500 for use in removing a 3/8, 1/2, 5/8, or ¾ inch diameter tubing from a ferrule fitting in accordance with the principles of the invention. In the FIGS., FIG. 7A is a front view of the fixed jaw 30, FIG. 7B is a side view of the fixed jaws 30 and the movable jaw 34 positioned next to each other, and FIG. 7C shows the fixed jaw and the movable jaw attached to a Mac Hose Clamp Vise HCP500 shown in phantom. Each jaw has two upstanding members 38 separated by a U shaped opening 40 which is sized to fit ferrules of 3/8, 1/2, 5/8, or ¾ inch tubing. Each upstanding member 38 forms a U Shaped opening that has as its gripping feature, a U shaped wedge with a blunt edge 39 running along the edge of the U that faces the opposing jaw. This wedge 39 extends inward and has a radius to prevent marring of the ferrule and protect a user's hands where the edges of the grippers of the two jaws when positioned next to each other can be located between the end of the fitting and the ridge of the ferrule. The lower portion 35 of the jaw is fixed at the end of the screw 32 of the MAC tool and the lower end of the jaw 34 has a threaded opening 36 which threads onto the screw 32. Rotation of the screw in a clockwise direction moves the jaw 34 toward the jaw 30 and a rotation of the screw in a counter clockwise direction moves the jaw 34 away from the jaw 30.

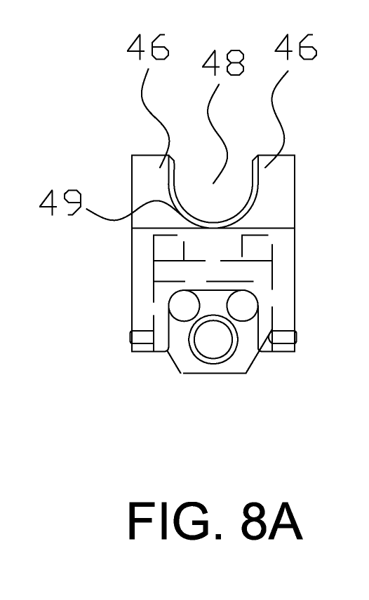

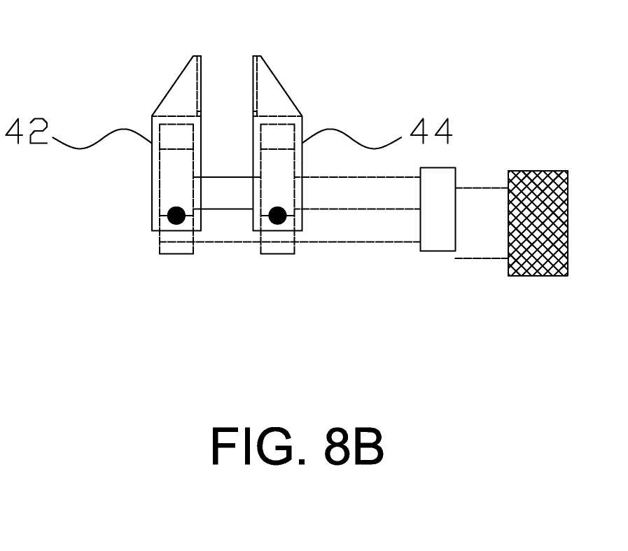

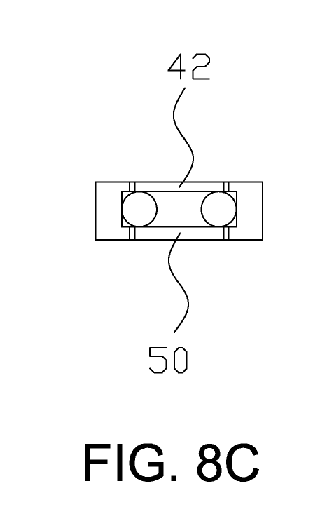

Referring to FIGS. 8A-8C, there is shown an embodiment of the invention where a pair of jaw members are adapted to be attached directly to the tool jaws of the Mac Hose Clamp Vise HCP500 shown in phantom for use in removing a 3/8, 1/2, 5/8, or ¾ inch diameter tubing from a ferrule fitting in accordance with the principles of the invention. In the FIGS., FIG. 8A is an end view of the fixed jaw 42 attached to the tool jaw of the MAC. Hose Clamp Vise HCP500, FIG. 8B is a side view of the movable jaw 44 attached to the tool jaw of the MAC. Hose Clamp Vise HCP500 shown in phantom, and FIG. 8C is a bottom view of one of the jaws 42, 44. Each jaw has two upstanding members 46 separated by a U shaped opening 48 which is sized to fit ferrules of 3/8, 1/2, 5/8, and ¾ inch tubing. Each upstanding member 46 forms a U Shaped opening 48 that has as its gripping feature, a U shaped wedge with a blunt edge 49 running along the edge of the U that faces the opposing jaw. This blunt wedge extends inward and has a radius to prevent marring of the ferrule and protect a user's hands where the blunt wedge shaped gripper runs around the inside of the U shaped opening extending inward along the side facing the opposite jaw, and when positioned next to each other can be located between the end of the fitting and the ridge 21 of the ferrule. The lower portion of each jaw has a rectangular opening 50 which is sized to fit around a jaw of the MAC tool. The lower portion of each jaw 42, 44 includes two threaded openings for receiving ball plungers, not shown, which are used to secure each of the jaws to a tool jaw of the MAC tool.

The jaws 42, 44 are designed to fit over the jaws of the MAC Tool Co. HCP500 Large Hose Clamp Vise. The tube is designed to engage the gap between the ferrule and body of the air fitting made by Parker Corp. that uses a nut and ferrule to capture a nylon tubing used in air brake and other air control systems in ground transportation systems. In use the tool pushes the ferrule and its captive tube from the body of the fitting in which it is engaged.

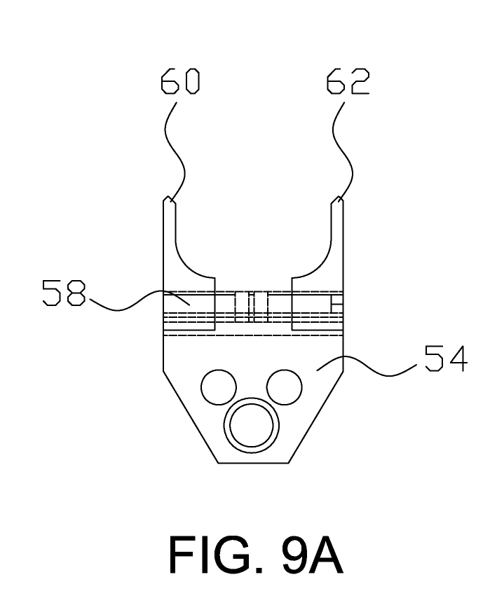

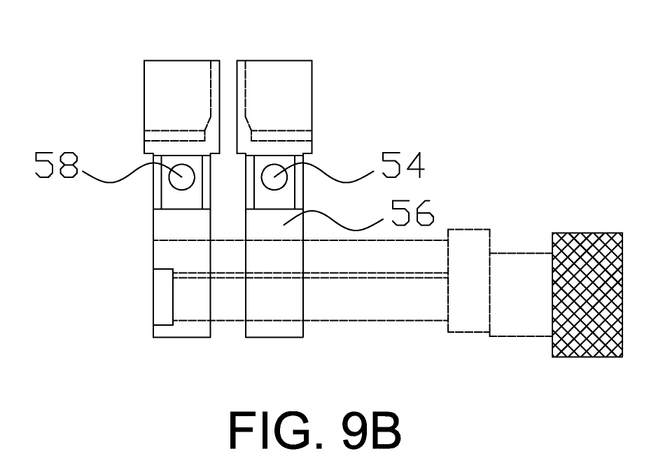

Referring to FIGS. 9A, 9B, there is shown an embodiment of the invention where each jaw member 54, 56 of a pair of jaw members are adjustable to fit multiple size fittings. The adjustment feature is a screw 58 which, when turned, moves a pair of blades 60, 62 in jaws 54, 56 in opposition. The two blades of the jaws have a straight wedge blade running along their inner surface, the surfaces facing each other, and work in conjunction with the blades of an adjacent jaw, and the blades engage the gap between the ferrule and body of an air fitting, to push the ferrule and its tube out of the body of the fitting. The jaws are made to be attached to the tool rails and screw of the Mac Hose Clamp Vise HCP500 for use in removing 3/8, 1/2, 5/8, or ¾ inch diameter tubing from ferrules in accordance with the principles of the invention. The adjustable jaw members shown in FIGS. 9A, 9B are installed onto the screw and rails of the MAC Tool HCP500 shown in phantom or equivalent thereby replacing the existing jaws of the MAC Tool HCP500.

In another embodiment the adjustable jaw members are designed to fit over the existing jaws of the MAC Tools HCP 500 large hose clamp vise as described for a previous embodiment. When positioned over the existing jaws of the MAC tool, the MAC tool now has an additional use and the original purpose of the MAC tools HCP500 large Hose clamp vise is still available.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A tool for removing the ferrule and tube from a pneumatic hose fitting comprising:
a first jaw having two upstanding members separated by a U shaped opening for receiving a pneumatic tube fitting of a specific diameter, wherein the upstanding members have a blunt wedge shaped gripper around the inside of the U shaped opening extending inward along the side facing the opposite jaw; and
a second jaw having two upstanding members separated by a U shaped opening for receiving the pneumatic tube fitting of a specific diameter, wherein the upstanding members have a blunt wedge shaped gripper around the inside of the U shaped opening extending inward along the side facing the opposite jaw;
wherein the first and second jaws are adapted to be coupled to a MAC Tools HCP500 Large Hose Clamp Vise or equivalent for movement toward and away from each other for removing a ferrule and tube from a pneumatic hose fitting made by the PARKER Corp.

2. The tool of claim 1 wherein the first and second jaws, when positioned adjacent to each other are adapted to engage the gap between the ferrule and body of the fitting.

3. The tool of claim 2 wherein the two jaws on the MAC Tool are removed and the first and second jaws are substituted therefore.

4. The tool of claim 2 wherein the first and second jaws are attached to the jaws on the MAC tool.

5. The tool of claim 4 wherein the first and second jaws each include at least one ball plunger for attachment to the jaws on the MAC tool.

6. The tool of claim 5 wherein each first and second jaws has two ball plungers.

7. The tool of claim 2 wherein the U shaped openings in the first and second jaws are sized to fit a ferrule of one quarter of an inch.

8. The tool of claim 2 wherein the U shaped openings in the first and second jaws are sized to fit a ferrule of three eighth of an inch.

9. The tool of claim 2 wherein the U shaped openings in the first and second jaws are sized to fit a ferrule of one half of an inch.

10. The tool of claim 2 wherein the U shaped openings in the first and second jaws are sized to fit a ferrule of five eighths of an inch.

11. The tool of claim 2 wherein the U shaped openings in the first and second jaws are sized to fit a ferrule of three quarters of an inch.

12. The tool of claim 2 wherein the two upstanding members of the first jaw are movable relative to each other along a first slot in the lower part of the first jaw to fit multiple size fittings; and the two upstanding members of the second jaw are movable relative to each other along a second slot in the lower part of the second jaw to fit multiple size fittings.

13. The tool of claim 12 wherein a first screw is coupled to the two upstanding members of the first jaw for moving the two upstanding members along the first slot; and a second screw is coupled to the two upstanding members of the second jaw for moving the two upstanding members along the second slot.

14. The tool of claim 13 wherein the multiple size fittings are between one quarter and three quarters of an inch.
